(19) United States
(12) Patent Application Publication
(10) Pub. No.: US 2007/0084723 A1
(43) Pub. Date: Apr. 19, 2007

(54) Structure of gas sensor element to provide enhanced measurement accuracy

(75) Inventors: Keigo Mizutani, Okazaki-shi (JP); Daisuke Makino, Ichinomiya-shi (JP); Kazunori Suzuki, Nagoya (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/580,305

(22) Filed: Oct. 13, 2006

(30) Foreign Application Priority Data
Oct. 13, 2005 (JP) 2005-298757

(51) Int. Cl. G01N 27/26

(52) U.S. Cl. 204/424

(57) ABSTRACT

A gas sensor element is designed to determine the concentration of a selected component contained in gas and includes a sensor cell. The sensor cell is equipped with two electrodes one of which is exposed to a gas chamber into which the gas flows from outside the gas sensor element. The electrodes connect with leads extending to external terminals exposed to the atmospheric air. One of the leads connecting with one of the electrodes exposed to the gas chamber is made of material which includes a mixture of a metallic composition and a ceramic composition and contains 7% or less by weight of the ceramic composition based on a total weight of the mixture. This results in a decrease in porosity of the lead, which reduces the intrusion of oxygen gas into the gas chamber, thereby enhancing the accuracy in determining the concentration of the selected component of the gas.

### CROSS REFERENCE TO RELATED DOCUMENT

The present application claims the benefits of Japanese Patent Application No. 2005-298757 filed on Oct. 13, 2005, the disclosure of which is incorporated herein by reference.

### BACKGROUND OF THE INVENTION

1 Technical Field of the Invention

The present invention relates generally to a gas sensor element which may be employed to measure the concentration of NOx contained in exhaust emissions of automotive engines, and more particularly to an improved structure of such a gas sensor element to provide enhanced measurement accuracy.

2 Background Art

The air population arising from automobile exhaust fumes has posed serious problems with modern life. The emission regulation, thus, has become severe year by year. For instance, in order to decrease harmful products contained in exhaust emissions, burning control systems working to control burning in the engine to inhibit generation of the harmful products or emission control systems working to clean up the exhaust emissions using a catalytic converter have been proposed. Techniques have also been proposed in the prior art for measuring the concentration of nitrogen oxides (NOx) that are typically harmful products contained in automotive exhaust gasses and feeding such a result back to the above systems to enhance the efficiency of purifying the exhaust emissions. For these reasons, gas sensor elements are being sought which are capable of measuring the concentration of NOx in automotive exhaust emissions accurately.

FIGS. 11 to 13 show an example of a known laminated gas sensor element 9.

The gas sensor element 9 includes a first measurement gas sub-chamber 911, a second measurement gas sub-chamber 912 into which exhaust gas of automotive engines are admitted, a sensor cell 92 working to measure the concentration of nitrogen oxides in the exhaust gas, and a pump cell 93. The pump cell 93 is equipped with pump cell electrodes 93a and 93b. The pump cell electrode 93a is exposed to the first measurement gas sub-chamber 911. When the voltage is applied to the pump cell electrodes 93a and 93b, the pump cell 93 works to pump oxygen from the first measurement gas sub-chamber 911 to a reference gas chamber 922 exposed to the atmospheric air or vice versa.

The gas sensor element 9 also includes, as illustrated in FIG. 12, a monitor cell 94 working to monitor the concentration of oxygen in the second measurement gas sub-chamber 912. A feedback circuit 975 works to control the operation of the pump cell 93 so as to keep the concentration of oxygen in the second measurement gas sub-chamber 912, as monitored by the monitor cell 94, at a constant level under feedback control.

The sensor cell 92 is designed to ionize O₂ and NOx to produce oxygen ions from the gas in the second measurement gas sub-chamber 912 to output a signal as function of the concentration of NOx. Specifically, the concentration of oxygen in the second measurement gas sub-chamber 912 is, as described above, kept constant, so that a change in amount of the oxygen ions, that is, an ion current flowing through the sensor cell 92 depends upon the concentration of NOx. Therefore, the output of the sensor cell 92 is a function of the concentration of NOx.

However, the output of the sensor cell 92 is usually a very weak electric current of the order of μA, thus requiring the need for keeping the concentration of oxygen in the second measurement gas sub-chamber 912 at a very lower level to ensure the accuracy in determining the concentration of NOx.

The gas sensor element 9, as illustrated in FIG. 11 to 13, has electrodes 951, external terminals 981 formed on an outer surface thereof, and leads 952 connecting them. These parts are made of cermet, that is, a mixture of ceramic and metallic compositions. This causes a small amount of oxygen gas in the air to enter the measurement gas chamber 91 through the terminals 981 and the leads 952, thereby resulting in decreased accuracy in determining the concentration of NOx.

In order to alleviate the above problem, Japanese Patent First Publication No. 2004-93199 teaches addition of Pt—Au to the leads 952 to increase the density thereof. There is, however, still left room for improvement in avoiding the entrance of the oxygen gas from outside the sensor element through the terminals 981.

### SUMMARY OF THE INVENTION

It is therefore a principal object of the invention to avoid the disadvantages of the prior art.

It is another object of the invention to provide an improved structure of a gas sensor element designed to provide enhanced measurement accuracy.

According to one aspect of the invention, there is provided a gas sensor element which may be employed in measuring the concentration of NOx contained in exhaust emissions of automotive vehicles.

The gas sensor element comprises: (a) a measurement gas chamber into which a measurement gas enter; (b) a sensor cell working to produce a signal as a function of a concentration of a given gas component contained in the measurement gas within the measurement gas chamber, the sensor cell including an oxygen ion-conductive solid electrolyte body and a first and a second sensor cell electrode affixed to surfaces of the solid electrolyte body, the second sensor cell electrode being exposed to the measurement gas chamber; (c) a first and a second sensor cell terminal disposed on surfaces of the gas sensor element; (d) a first sensor cell lead connecting between the first sensor cell electrode and the first sensor cell terminal; and (e) a second sensor cell lead connecting between the second sensor cell electrode and the second sensor cell terminal. At least a portion of the second sensor cell lead is made of material which includes a mixture of a metallic composition and a ceramic composition and contains 7% or less by weight of the ceramic composition based on a total weight of the mixture, thereby resulting in a decrease in porosity of the portion of the second sensor cell lead leading to the measurement gas chamber through the second sensor cell electrode, which reduces the intrusion of oxygen gas from the second sensor cell lead into the measurement gas chamber. This decreases a very weak current or offset current, as produced by the sensor cell, in the absence of the given gas component in the measurement gas chamber, thus resulting in enhanced accuracy in determining the concentration of the given gas component.

The metallic composition may include Pt or Au. The ceramic composition may include ZrO₂ or Al₂O₃.

In the preferred mode of the invention, the at least the portion of the second sensor cell lead may contain 1% or more by weight of the ceramic composition based on the total weight of the mixture. This avoids physical separation of the second sensor cell lead from the solid electrolyte body arising from a difference in rate of shrinkage therebetween during firing.

The sensor element may further comprise a pump cell, a first and a second pump cell terminal, and a first and a second pump cell lead. The pump cell works to regulate a concentration of oxygen within the measurement gas chamber to a given level and includes an oxygen ion-conductive solid electrolyte body and a first and a second pump cell electrode affixed to surfaces of the solid electrolyte body. The second pump cell electrode is exposed to the measurement gas chamber. The first and second pump cell terminals are disposed on surfaces of the gas sensor element. The first pump cell lead connects between the first pump cell electrode and the first pump cell terminal electrically. The second pump cell lead connects between the second pump cell electrode and the second pump cell terminal. At least a portion of the second pump cell lead is made of material which includes a mixture of a metallic composition and a ceramic composition and contains 7% or less by weight of the ceramic composition based on a total weight of the mixture.

The at least the portion of the second pump cell lead may contain 1% or more by weight of the ceramic composition based on the total weight of the mixture.

The gas sensor element may further comprise a monitor cell, a first and a second monitor cell terminal, and a first and a second monitor cell lead. The monitor cell works to monitor a concentration of oxygen within the measurement gas chamber and includes an oxygen ion-conductive solid electrolyte body and a first and a second monitor cell electrode affixed to surfaces of the solid electrolyte body. The second monitor cell electrode is exposed to the measurement gas chamber. The first and second monitor cell terminals is disposed on surfaces of the gas sensor element. The first monitor cell lead connects between the first monitor cell electrode and the first monitor cell terminal electrically. The second monitor cell lead connects between the second monitor cell electrode and the second monitor cell terminal. At least a portion of the second monitor cell lead is made of material which includes a mixture of a metallic composition and a ceramic composition and contains 1% to 7% by weight of the ceramic composition based on a total weight of the mixture.

Each of the first and second sensor cell leads may contain a metallic composition of Rh. This avoids physical separation of the first and second sensor cell leads from the solid electrolyte body arising from a difference in rate of shrinkage therebetween during firing.

Similarly, each of the first and second pump cell leads may contain a metallic composition of Rh.

Similarly, each of the first and second monitor cell leads may contain a metallic composition of Rh.

Each of the first and second sensor cell leads may have a thickness of 5 μm or less, preferably 3 μm or less. This avoids physical separation of the first and second sensor cell leads from the solid electrolyte body.

Similarly, each of the first and second pump cell leads may have a thickness of 5 μm or less.

Similarly, each of the first and second monitor cell leads may have a thickness of 5 μm or less.

The monitor cell works to produce a signal indicative of the concentration of oxygen within the measurement gas chamber for use in controlling the voltage applied to the pump cell.

The sensor cell may be designed to produce an electric current as a function of the concentration of the given gas component contained in the measurement gas within the measurement gas chamber.

The given gas component may be a nitrogen oxide.

According to the second aspect of the invention, there is provided a gas sensor element which comprise: (a) a measurement gas chamber into which a measurement gas enter; (b) a sensor cell working to produce a signal as a function of a concentration of a given gas component contained in the measurement gas within the measurement gas chamber, the sensor cell including an oxygen ion-conductive solid electrolyte body and a first and a second sensor cell electrode affixed to surfaces of the solid electrolyte body, the second sensor cell electrode being exposed to the measurement gas chamber; (c) a first and a second sensor cell terminal disposed on surfaces of the gas sensor element; (d) a first sensor cell lead connecting between the first sensor cell electrode and the first sensor cell terminal; and (e) a second sensor cell lead connecting between the second sensor cell electrode and the second sensor cell terminal, at least a portion of the second sensor cell lead contains a glass composition.

If each of the second sensor cell lead has pinholes before fired, the glass composition will melt during firing of the gas sensor element, so that it covers in the pinholes, thus resulting in a decreased porosity of the second sensor cell lead. This eliminates or reduces the entrance of the oxygen gas from the second sensor cell terminal, thus ensuring the accuracy in measuring the concentration of the given gas component.

In the preferred mode of the invention, the gas sensor element may further comprise a pump cell, a first and a second pump cell terminal, and a first and a second pump cell lead. The pump cell works to regulate a concentration of oxygen within the measurement gas chamber to a given level and includes an oxygen ion-conductive solid electrolyte body and a first and a second pump cell electrode affixed to surfaces of the solid electrolyte body. The second pump cell electrode is exposed to the measurement gas chamber. The first and second pump cell terminals is disposed on surfaces of the gas sensor element. The first pump cell lead connects between the first pump cell electrode and the first pump cell terminal electrically. The second pump cell lead connects between the second pump cell electrode and the second pump cell terminal. At least a portion of the second pump cell lead containing a glass composition.

The gas sensor element may further comprise a monitor cell, a first and a second monitor cell terminal, and a first and a second monitor cell lead. The monitor cell works to monitor a concentration of oxygen within the measurement gas chamber and including an oxygen ion-conductive solid electrolyte body and a first and a second monitor cell electrode affixed to surfaces of the solid electrolyte body. The second monitor cell electrode is exposed to the measurement gas chamber. The first and second monitor cell terminals is disposed on surfaces of the gas sensor element. The first monitor cell lead connects between the first monitor cell electrode and the first monitor cell terminal electrically. The second monitor cell lead connects between the second monitor cell electrode and the second monitor cell terminal. At least a portion of the second monitor cell lead containing a glass composition.

Each of the first and second sensor cell leads may contain a metallic composition of Rh. This avoids physical separation of the first and second sensor cell leads from the solid electrolyte body arising from a difference in rate of shrinkage therebetween during firing.

Each of the first and second sensor cell leads may have a thickness of 5 μm or less.

Similarly, each of the first and second pump cell leads may have a thickness of 5 μm or less.

Similarly, each of the first and second monitor cell leads may have a thickness of 5 μm or less.

The monitor cell works to produce a signal indicative of the concentration of oxygen within the measurement gas chamber for use in controlling the voltage applied to the pump cell.

The sensor cell may be designed to produce an electric current as a function of the concentration of the given gas component contained in the measurement gas within the measurement gas chamber.

The given gas component may be a nitrogen oxide.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor element according to the first embodiment of the invention;

FIG. 2 is a transverse sectional view as taken along the line A-A in FIG. 1;

FIG. 3 is an exploded view which shows the gas sensor element of FIG. 1;

FIG. 4 is a perspective view which shows a lead connecting with an electrode;

FIG. 5 is a longitudinal sectional view which shows a gas sensor element according to the third embodiment of the invention;

FIG. 6 is a transverse sectional view as taken along the line B-B in FIG. 5;

FIG. 7 is a graph which demonstrates an experimentally derived relation between an offset current, as produced by the gas sensor element of FIG. 1, and the content of ceramic composition in a lead;

FIG. 8 is a longitudinal sectional view which shows a gas sensor element according to the fourth embodiment of the invention;

FIG. 9 is a longitudinal sectional view which shows a gas sensor element according to the fifth embodiment of the invention;

FIG. 10 is a transverse sectional view as taken along the line C-C in FIG. 9;

FIG. 11 is a longitudinal sectional view which shows an example of a typical gas sensor element;

FIG. 12 is a transverse sectional view as taken along the line D-D in FIG. 11; and

FIG. 13 is an exploded view which shows the gas sensor element of FIG. 11.

### DESCRIPTION OF THE PREFERRED EMBODIMENTS

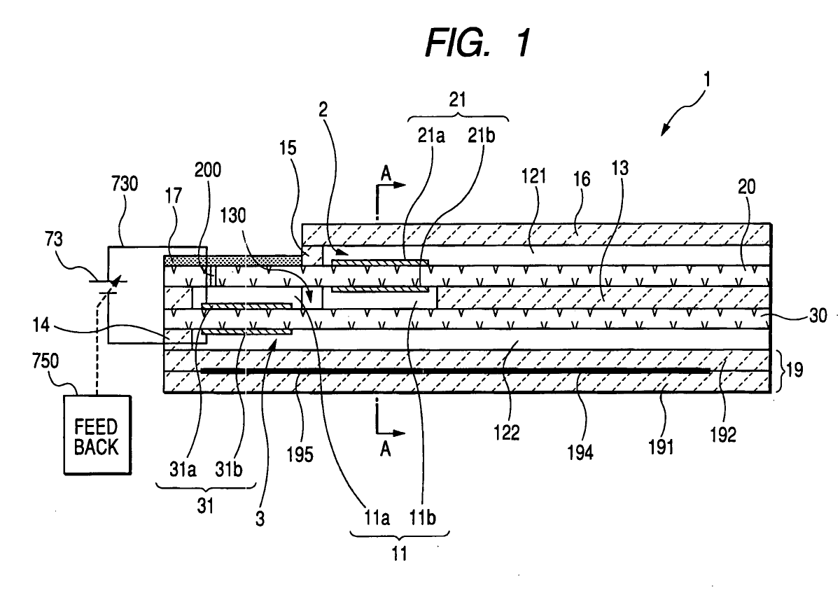

Referring to the drawings, wherein like reference numbers refer to like parts in several views, particularly to FIGS. 1 to 4, there is shown a gas sensor element 1 according to the first embodiment of the invention which is to be mounted within a gas sensor which may be installed in an exhaust pipe of an internal combustion engine to measure the concentration of oxygen (O₂) or NOx (i.e., Nitrogen Oxides) contained in exhaust emissions of the engine for use in engine burning control and/or catalytic systems.

The gas sensor element 1 includes generally a measurement gas chamber 11 into which gas to be measured (will also be referred to as a measurement gas below) is admitted, a sensor cell 2 working to output a signal as a function of the concentration of a preselected component, such as NOx, of the measurement gas, a pump cell 3 working to pump oxygen molecules out of or into the measurement gas chamber 11 selectively to keep the concentration of oxygen (O₂) in the measurement gas chamber 11 at a given level, a monitor cell 4 working to monitor the concentration of oxygen (O₂) in the measurement gas chamber 11, a first reference gas chamber 121, and a second reference gas chamber 122.

The sensor cell 2 is, as illustrated in FIGS. 1 to 3, made up of an oxygen ion-conductive solid electrolyte plate 20 and a pair of sensor cell electrodes 21 (also denoted by 21a and 21b below) which are affixed to opposed surfaces of the solid electrolyte plate 20. The sensor cell electrodes 21b is exposed to the measurement gas chamber 11.

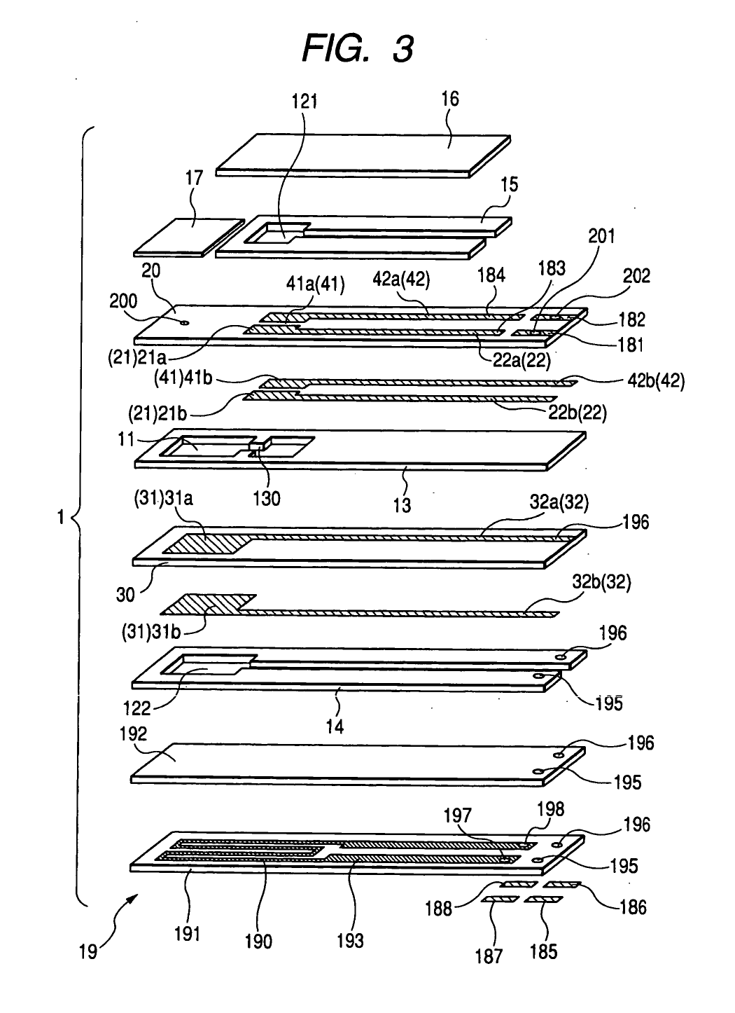

The sensor cell electrodes 21 are, as illustrated in FIG. 3, connected electrically to terminals 181 and 183 through leads 22 (also denoted by 22a and 22b below).

The lead 22b connecting with the sensor cell electrode 21b exposed to the measurement gas chamber 11 is made of a mixture of metallic and ceramic components containing 1% to 7% by weight of the ceramic component based on the total weight of the mixture (i.e., the lead 22b).

The pump cell 3 is made up of an oxygen ion-conductive solid electrolyte plate 30 and pump cell electrodes 31 (also denoted by 31a and 31b below) which are affixed to opposed surfaces of the solid electrolyte plate 30. The pump cell electrode 31a is exposed to the measurement gas chamber 11.

The pump cell electrodes 31 are, as illustrated in FIG. 3, connected electrically with terminals 185 and 186 affixed to the surface of the gas sensor element 1 through leads 32 (also denoted by 32a and 32b below). The lead 32a connecting with the pump cell electrode 31a exposed to the measurement gas chamber 11 is made of a mixture of metallic and ceramic materials containing 1% to 7% by weight of the ceramic material based on the total weight of the mixture.

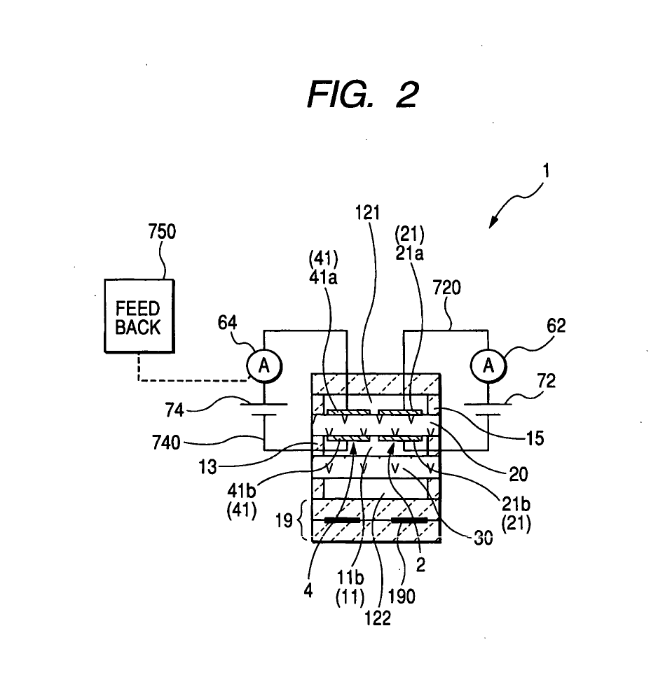

The monitor cell 4 is, as illustrated in FIGS. 2 and 3, made up of the oxygen ion-conductive solid electrolyte plate 20 and monitor cell electrodes 41 (also denoted by 41a and 41b below) affixed to opposed surfaces of the solid electrolyte plate 20. The monitor cell electrode 41b is exposed to the measurement gas chamber 11.

The monitor cell electrodes 41 are, as illustrated in FIG. 3, connected electrically to terminals 182 and 184 through leads 42 (also denoted by 42a and 42b below).

The lead 42b connecting with the monitor cell electrode 41b exposed to the measurement gas chamber 11 is made of a mixture of metallic and ceramic components containing 1% to 7% by weight of the ceramic component based on the total weight of the mixture.

The gas sensor element 1 of this embodiment is usually mounted within a gas sensor which may be installed in an exhaust pipe of an automotive engine to measure the concentration of O₂ or NOx contained in exhaust emissions of the engine for use in engine burning control and/or catalytic systems. Specifically, the gas sensor element 1 may be used as a sensor element of an O₂, NOx, or air-fuel ratio sensor. The following discussion will refer to, as an example, a case of use of the gas sensor element 1 in measuring the concentration of NOx in exhaust gasses of the automotive engine.

The gas sensor element 1 is, as can be seen from FIGS. 1 to 3, made of a laminate of the solid electrolyte plate 20, a spacer 13 defining the measurement gas chamber 11, the solid electrolyte plate 30, a spacer 15 defining the first reference gas chamber 121, a spacer 14 defining the second reference gas chamber 122, and a ceramic heater 19. The heater 19 works to heat the pump cell 3, the sensor cell 2, and the monitor cell 4 up to an activation temperature thereof.

The measurement gas chamber 11 is a chamber into which exhaust gasses of the automotive engine are admitted and which is defined by windows, as clearly illustrated in FIG. 3, formed in the spacer 13 interposed between the solid electrolyte plates 20 and 30. The measurement gas chamber 11 is, as can be seen in FIGS. 1 to 3, made up of two sub-chambers: a first measurement gas sub-chamber 11a and a second measurement gas sub-chamber 11b. The first measurement gas sub-chamber 11a is located upstream of a flow of the exhaust gasses (i.e., the left side of the drawing) and communicates with the second measurement gas sub-chamber 11b through an orifice 130 formed between the windows of the solid electrolyte plate 13.

The first measurement gas sub-chamber 11a, as illustrated in FIGS. 1 and 3, leads to outside the gas sensor element 1 through a pinhole 200 which works as a diffusion resistor to produce a preselected diffusion resistance to which the measurement gas introduced from outside the gas sensor element 1 is subjected, so that it flows into the measurement gas chamber 11 at a given diffusion velocity or rate. Specifically, the pinhole 200 has a size which is so selected that a rate or velocity of diffusion of the measurement gas (i.e. the exhaust gasses) flowing into the first measurement gas sub-chamber 11a may be a desired value.

The solid electrolyte plate 20 is partially covered with a porous diffusion resistance layer 17 made of a Al₂O₃. The porous diffusion resistance layer 17 is disposed over an inlet of the pinhole 200 and works to avoid clogging of the pinhole 200 and poisoning of the pump cell electrode 31a, the monitor cell electrode 41b, and the sensor cell electrode 21b.

The gas sensor element 1 includes, as described above, the first and second reference gas chambers 121 and 122 to which atmospheric air is admitted as a reference gas having a constant concentration of oxygen.

The first reference gas chamber 121 is, as shown in FIGS. 1 and 3, defined by the solid electrolyte plate 20, the spacer 15, and an insulating plate 16. The second reference gas chamber 122 is defined by the solid electrolyte plate 30, the spacer 14, and a cover plate 192. The solid electrolyte plates 20 and 30 are each made of an oxygen ion-conductive electrolyte such as zirconia or ceria.

The sensor cell 2, as illustrated in FIGS. 1 to 3, consists of the solid electrolyte plate 20, the sensor cell electrode 21b facing the second measurement gas sub-chamber 11b, and the sensor cell electrode 21a facing the first reference gas chamber 121.

The sensor cell electrodes 21a and 21b are, as shown in FIG. 2, connected to a sensor circuit 720 equipped with a power supply 72 and a current detector or ammeter 62.

The sensor cell electrodes 21a and 21b are each formed by a porous electrode made of cermet containing metal compositions which consist mainly of Pt and ceramic compositions which consist mainly of ZrO₂ in order to facilitate the diffusion of the gas within the electrode and also enhance the reaction between the electrode and the solid electrolyte plate 20. For instance, the porous electrode may contain 10% to 20% by weight of the ceramic compositions based on the total weight thereof (i.e., the total weight of the ceramic and metallic compositions).

The sensor cell electrode 21b exposed to the measurement gas chamber 11 is made of Pt—Rh active to dissociate or decompose NOx. Metallic compositions of the sensor cell electrode 21b preferably contain 10% to 50% by weight of Rn.

The sensor cell electrode 21a is, as illustrated in FIG. 3, connected electrically with a terminal 183 through a conductive lead 22a. The sensor cell electrode 21b is connected electrically with a terminal 181 through the lead 22b and a conductor-coated through-hole 201 formed in the solid electrolyte plate 20.

The lead 22b is made of metallic compositions containing Rh. Specifically, a content of Rh is preferably 1% or more by weight based on the total weight of the metallic compositions consisting primarily of Pt. The thickness of the lead 22b is 5 μm or less, preferably 3 μm or less.

The pump cell 3, as illustrated in FIGS. 1 to 3, consists of the solid electrolyte plate 30, the pump cell electrode 31a facing the first measurement gas sub-chamber 11a, and the pump cell electrode 31b facing the second reference gas chamber 122.

The pump cell electrodes 31a and 31b are, as shown in FIG. 1, connected to a pump circuit 730 equipped with a power supply 73.

The pump cell electrodes 31a and 31b are, like the sensor cell electrodes 21, each made of cermet containing metal compositions which consist primarily of Pt and ceramic compositions which consist primarily of ZrO₂. For instance, each of the pump cell electrodes 31a and 31b may contain 10% to 20% by weight of the ceramic compositions based on the total weight thereof.

The pump cell electrode 31a exposed to the measurement gas chamber 11 is made of Pt—Au inactive to dissociate or decompose NOx. Metallic compositions of the pump cell electrode 31a preferably contain 1% to 10% by weight of Au based on the total weight thereof.

The pump cell electrode 31a, as illustrated in FIG. 3, extends to a conductive lead 32a which connects electrically with an external terminal 186 through a conductor-coated hole 196 formed in the solid electrolyte plate 30, the spacer 14, a heater base 191, the cover plate 192. The pump cell electrode 31b extends to a lead 32b which connects electrically with the external terminal 185 through a conductor-coated hole 195 formed in the spacer 14, the heater base 191, and the cover plate 192.

The lead 32a is made of metallic compositions containing 1% or more by weight of Rh based on the total weight thereof and has a thickness of 5 μm or less, preferably 3 μm or less.

The monitor cell 4, as illustrated in FIGS. 2 and 3, consists of the solid electrolyte plate 20, the monitor cell electrode 41a facing the second measurement gas sub-chamber 11b, and the monitor cell electrode 41a facing the first reference gas chamber 121.

The monitor cell electrodes 41a and 41b are, as shown in FIG. 2, connected to a monitor circuit 740 equipped with a power supply 74 and an ammeter 64.

The monitor cell electrodes 41a and 41b are, like the sensor cell electrodes 21, each made of cermet containing metal compositions which consist primarily of Pt and ceramic compositions which consist primarily of ZrO₂. For instance, each of the monitor cell electrodes 41a and 41b may contain 10% to 20% by weight of the ceramic compositions based on the total weight thereof.

The monitor cell electrode 41b exposed to the measurement gas chamber 11 is made of Pt—Au inactive to dissociate or decompose NOx. Metallic compositions of the pump cell electrode 41b preferably contain 1% to 10% by weight of Au based on the total weight thereof.

The monitor cell electrode 41a, as illustrated in FIG. 3, extends to a conductive lead 42a which connects electrically with an external terminal 184. The monitor cell electrode 41b extends to a lead 42b which connects electrically with a terminal 182 through a conductor-coated hole 202 formed in the solid electrolyte plate 20.

The lead 42a is made of metallic compositions containing 1% or more by weight of Rh based on the total weight thereof and has a thickness of 5 μm or less, preferably 3 μm or less.

The monitor cell 4 is, as illustrated in FIGS. 1 and 2, connected to a feedback circuit 750 which works to monitor an output of the ammeter 64 to control an operation of the pump cell 3.

The ceramic heater 19 is, as shown in FIG. 3, made up of the heater base 191, a heating element 190 affixed to the heater base 191, and the cover plate 192 disposed over the heating element 190.

The heating element 190 is printed in a given pattern on the heater base 191 formed by a sheet made of Al₂O₃. The heating element 190 is made of cermet such as ceramic material containing Pt and Al₂O₃. The heating element 190 is supplied with an electric power from a sensor controller (not shown) provided outside the gas sensor element 1 and heats the pump cell 3, the monitor cell 4, and the sensor cell 2 up to an activation temperature required to activate the cells 3, 4, and 2 sufficiently. The supply of power to the heating element 190 is, as illustrated in FIG. 3, achieved through a lead 193 formed on the heater base 191 in connection with the heating element 190, through-holes 197 and 198, and external terminals 187 and 188.

The solid electrolyte plates 20 and 30, the spacers 13, 14, and 15, the cover plate 192, and the heater base 191 are each made of a sheet formed by, for example, the doctor-blade method or the extrusion molding.

The operation of the gas sensor element 1 will be described below.

Referring to FIGS. 1 and 3, the measurement gas (i.e., exhaust gas of the automotive engine) passes through the porous diffusion resistance layer 17 and the pinhole 200 and flows into the first measurement gas sub-chamber 11a. The amount of the measurement gas flowing into the first measurement gas sub-chamber 11a depends upon diffusion resistances of the porous diffusion resistance layer 17 and the pinhole 200.

The pump circuit 730 works to apply through the power supply 73 the voltage across the pump cell electrodes 31a and 31b of the pump cell 3 so that the pump cell electrode 31b exposed to the second reference gas chamber 122 may be at a higher potential (i.e., +potential). This causes oxygen in the measurement gas to be reduced by the pump cell electrode 31a exposed to the measurement gas chamber 11 to produce oxygen ions. The oxygen ions are pumped to the pump cell electrode 31b exposed to the second reference gas chamber 122. Conversely, when the pump circuit 730 applies the voltage to the pump cell 3 so that the pump cell electrode 31a may be at a higher potential, it will cause oxygen in the air within the second reference gas chamber 122 to be reduced by the pump cell electrode 31b to produce oxygen ions which are, in turn, pumped to the pump cell electrode 31a. Specifically, the pump circuit 730 controls the application of the voltage to the pump cell 3 to regulate the concentration of oxygen within the first measurement gas sub-chamber 11a.

The gas entering the first measurement gas sub-chamber 11a goes to the second measurement gas sub-chamber 11b through the orifice 130.

The monitor circuit 740 works to apply through the power supply 74 a constant voltage (e.g., 0.40 V) to the monitor cell 4 so that the monitor cell electrode 41a exposed to the first reference gas chamber 121 may be at a higher potential. This causes oxygen in the measurement gas within the second measurement gas sub-chamber 11b to be reduced by the monitor cell electrode 41b exposed to the second measurement gas sub-chamber 11b to produce oxygen ions. The oxygen ions are pumped to the monitor cell electrode 41a.

The monitor cell electrode 41b is, as described above, implemented by the Pt—Au cermet electrode which hardly decompose NOx. This causes an oxygen ion current to flow between the monitor cell electrodes 41a and 41b as a function of the concentration of oxygen in the measurement gas flowing from the porous diffusion resistance layer 17 and the pinhole 200 to the first measurement gas sub-chamber 11a and to the second measurement gas sub-chamber 11b and reaching the monitor cell electrode 41b. The concentration of oxygen in the second measurement gas sub-chamber 11b may, therefore, by determined by sampling the current flowing through the monitor cell 4.

The feedback circuit 750 works to monitor the current flowing through the monitor cell 4 through the ammeter 64 to control the operation of the pump cell 3 so as to keep the concentration of oxygen within the second measurement gas sub-chamber 11b at a constant level. Specifically, the feedback circuit 750 monitors the output of the ammeter 64 and controls the voltage applied to the pump cell 3 so as to bring the current, as measured by the ammeter 64, into agreement with a constant level, for example, 0.1 μA.

The sensor circuit 720 works to apply through the power supply 72 a constant voltage (e.g., 0.40 V) to the sensor cell 2 so that the sensor cell electrode 21a exposed to the first reference gas chamber 121 may be at a higher potential. The sensor cell electrode 21b is, as described above, implemented by the cermet electrode containing Pt—Rh active to dissociate or decompose NOx. NOx and oxygen within the second measurement gas sub-chamber 11b are, thus, reduced by the sensor cell electrode 21b to produce oxygen ions. The oxygen ions are pumped to the sensor cell electrode 21a.

The feedback circuit 750 is, as described above, designed to control the operation of the pump cell 3 so that the current flowing between the monitor cell electrodes 41a and 41b may be kept at a constant level of, for example, 0.1 g A. Therefore, in the absence of NOx in the measurement gas, the current flowing between the sensor cell electrodes 21a and 21b is kept at a constant level of, for example, of 0.1 μA.

In the presence of NOx in the measurement gas, the oxygen ions, as produced by decomposing NOx, are increased, thus causing the current flowing through the sensor cell 2 to be greater in amount than that flowing through the monitor cell 4. Specifically, the output of the sensor cell 2 is a function of the concentration of NOx in the measurement gas.

The features of the structure of the gas sensor 1 will be described below.

The lead 22b connecting with the sensor cell electrode 21b facing the measurement gas chamber 11 is made of a mixture of metallic and ceramic compositions in which a content of the ceramic compositions is 1% to 7% by weight based on the total weight of the metallic and ceramic compositions. This results in a decreased porosity of the lead 22b, thereby eliminating or reducing the entrance of the oxygen gas from the external terminal 181 exposed outside the gas sensor 1.

Specifically, the lead 22b serves to prevent the air containing oxygen around the external terminal 181 from reaching the measurement gas chamber 11 (i.e., the second measurement gas sub-chamber 11b) through the holes 201. This reduces or eliminates a weak current or offset current, as produced by the sensor cell 2, in the presence of NOx in the measurement gas chamber 11, which results in increased accuracy in determining the concentration of NOx contained in the measurement gas flowing into the measurement gas chamber 11 from the pinhole 200.

The ceramic content of 1% or more by weight serves to decrease differences in the rate of shrinkage between the lead 22b and the solid electrolyte plate 20 during firing of the gas sensor element 1 and in the rate of expansion therebetween during use of the gas sensor element 1 to avoid physical separation between the lead 22b and the solid electrolyte plate 20.

Similarly, the lead 32a connecting with the pump cell electrode 31a facing the measurement gas chamber 11 is made of a mixture of metallic and ceramic compositions in which a content of the ceramic compositions is 1% to 7% by weight based on the total weight of the metallic and ceramic compositions. This eliminates or reduces the entrance of the oxygen gas from the external terminal 186 exposed outside the gas sensor 1 and avoids physical separation between the lead 32a and the solid electrolyte plate 30, which results in increased accuracy in determining the concentration of NOx contained in the measurement gas flowing into the measurement gas chamber 11 from the pinhole 200.

Similarly, the lead 42b connecting with the monitor cell electrode 41b facing the measurement gas chamber 11 is made of a mixture of metallic and ceramic compositions in which a content of the ceramic compositions is 1% to 7% by weight based on the total weight of the metallic and ceramic compositions. This eliminates or reduces the entrance of the oxygen gas from the external terminal 182 exposed outside the gas sensor 1 and avoids physical separation between the lead 42b and the solid electrolyte plate 20, which results in increased accuracy in determining the concentration of NOx contained in the measurement gas flowing into the measurement gas chamber 11 from the pinhole 200.

Each of the leads 22b, 32a, and 42b contains the metallic composition of Rh which is higher in melting point and hardly sintered, thus greatly decreasing a difference in rate of shrinkage between each of the leads 22b, 32a, and 42b and a corresponding one of the solid electrolyte plates 20 and 30 when being fired. This avoids physical separation of each of the leads 22b, 32a, and 42b from one of the solid electrolyte plates 20 and 30.

Each of the leads 22b, 32a, and 42b has a thickness of 5 μm or less, preferably 3 μm or less, thereby minimizing the physical separation of each of the leads 22b, 32a, and 42b from one of the solid electrolyte plates 20 and 30. Especially, when the thickness is less than or equal to 3 μm, it enhances the effect of minimization of such physical separation.

The voltage to be applied to the pump cell 3 is, as described above, controlled using the output of the monitor cell 4. Specifically, the operation of the pump cell 3 is controlled as a function of the concentration of oxygen in the measurement gas chamber 11, as monitored by the monitor cell 4, thus regulating the concentration of oxygen contained in the measurement gas to ensure the accuracy in measuring the concentration of NOx.

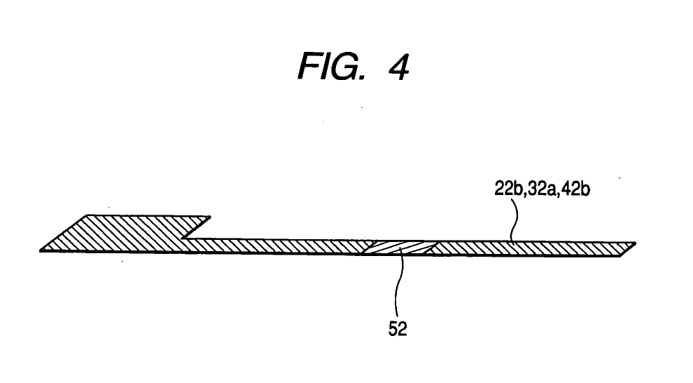

Each of the leads 22b, 32a, and 42b, as described above, contains 1% to 7% by weight of the ceramic compositions as a whole, but may alternatively, as illustrated in FIG. 4, be made to contain 1% to 7% by weight of the ceramic compositions only in an area 52.

The gas sensor element 1 of the second embodiment will be described below.

The leads 22b, 32a, and 42b each contain a glass composition. Specifically, each of the leads 22b, 32a, and 42b made of a mixture of metallic compositions which consist mainly of Pt, ceramic compositions which consist mainly of ZrO₂, and glass compositions which consist mainly of SiO₂ or B₂O₃. Each of the leads 22b, 32a, and 42b contains 1% to 30%, preferably 5% to 10% by weight of the glass compositions based on the total weight thereof. Other arrangements are identical with those in the first embodiment, and explanation thereof in detail will be omitted here.

If each of the leads 22b, 32a, and 42b has pinholes before fired, the glass compositions will melt during firing of the gas sensor element 1, so that they cover in the pinholes, thus resulting in a decreased porosity of each of the leads 22b, 32a, and 42b. This eliminates or reduces the entrance of the oxygen gas from the external terminal 181, 186, or 182, thus ensuring the accuracy in measuring the concentration of NOx.

Each of the leads 22b, 32a, and 42b may contain the glass composition in at least a portion thereof.

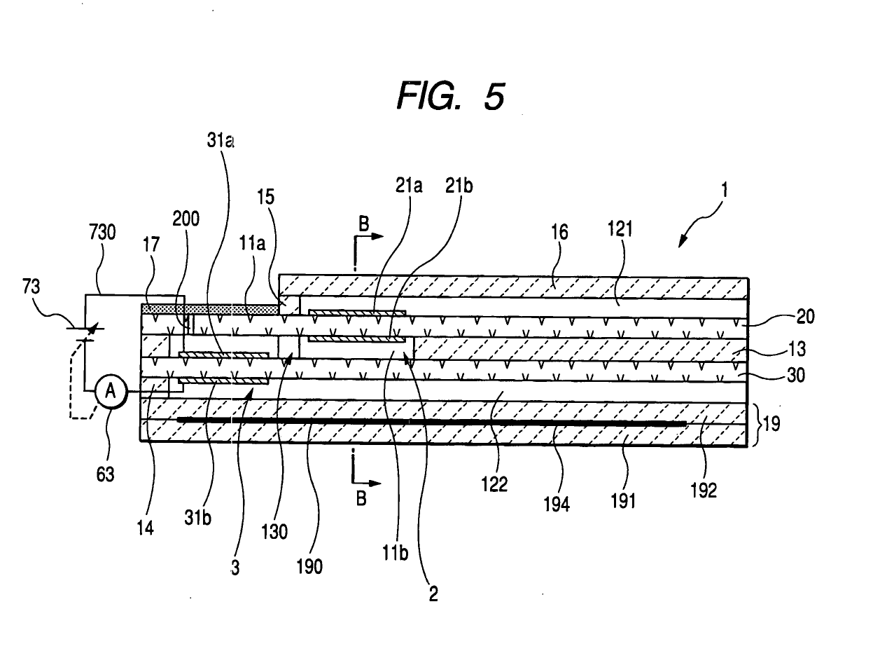

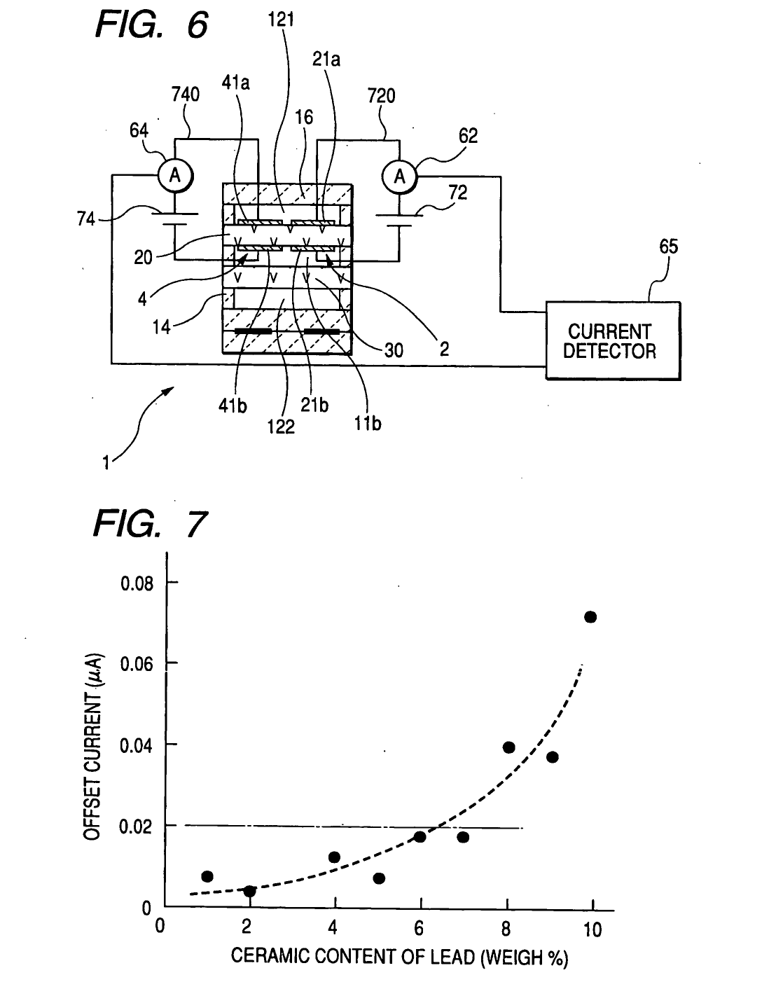

FIGS. 5 and 6 show the gas sensor element 1 of the third embodiment of the invention which is employed in a limiting current control system in which the pump circuit 730 works to look up a map table stored therein which lists relations between voltages to be applied to the pump cell 3 and resultant currents flowing through the pump cell 3 to determine a target voltage to be applied to the pump cell 3 as a function the concentration of oxygen in the measurement gas chamber 11, which results in production of a limiting current between the pump cell electrodes 31a and 31b, thereby keeping the concentration of oxygen in the measurement gas chamber 11 at a given lower level.

A current detector 65 is, as illustrated in FIG. 6, connected to the ammeters 62 and 64 and works to sample a difference between currents flowing through the sensor cell electrodes 21a and 21b and through the monitor cell electrodes 41a and 41b as an output of the gas sensor element 1 indicative of the concentration NOx. This reduces the effect of a variation in concentration of oxygen in the measurement gas chamber 11 on determination of the concentration of NOx.

Other arrangements and operations are identical with those in the first embodiment, and explanation thereof in detail will be omitted here.

FIG. 7 is a graph which demonstrates offset currents flowing through the sensor cell electrodes 21a and 21b for different values of the ceramic content of the lead 22b which were experimentally measured when 0.4 V was applied to each of the sensor cell 2, the pump cell 3, and the monitor cell 4 of the gas sensor element 1 of the first embodiment in a nitrogen gas atmosphere.

The graph shows that the offset current decreases with a decrease in the ceramic content of the lead 22b, and especially when the ceramic content is 7% by weight or less, it results in a great decrease in the offset current, that is, the offset current falls within a desirable range.

However, we have found that, when the ceramic content of the lead 22b is less than 1% by weight, it will results in an increased difference in rate of shrinkage between the lead 22b and the solid electrolyte plate 20 when being fired, thus facilitating the separation of the lead 22b from the solid electrolyte plate 20, and when the ceramic content is zero (0) % by weight, it will result in complete separation of the lead 22b from the solid electrolyte plate 20.

From the graph of FIG. 7 and the above observation, it is found that the lead 22b is preferably made to contain 1% to 7%, more preferably 2% to 5% by weight of the ceramic compositions based on the total weight thereof.

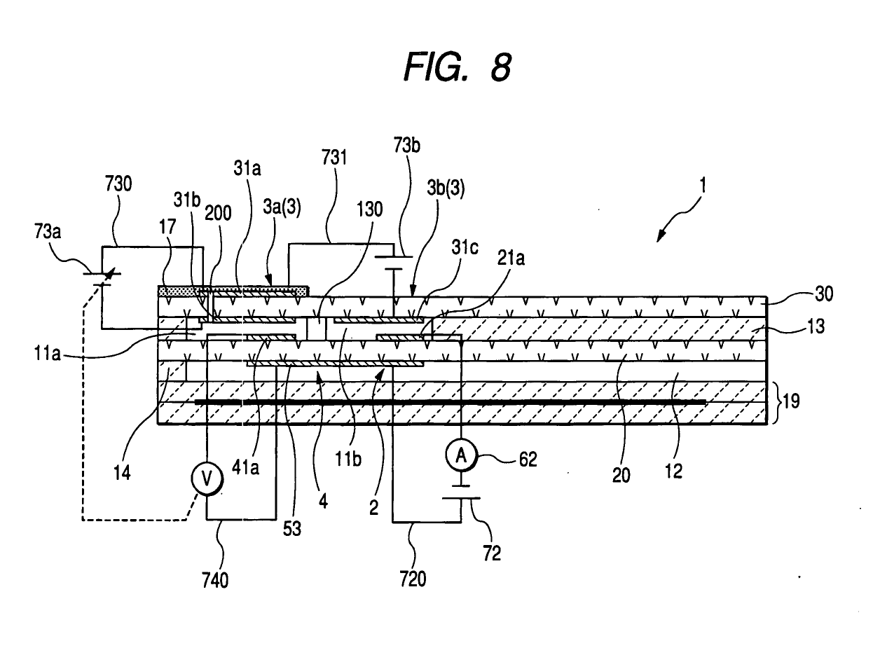

FIG. 8 shows the gas sensor element 1 according to the fourth embodiment of the invention which is employed with an electromotive force control system which works to determine the concentration of oxygen within the measurement gas chamber 11 (i.e., the first measurement gas sub-chamber 11a) as a function of an electromotive force developed by the monitor cell 4.

The monitor cell 4 is made up of the solid electrolyte plate 20, the monitor cell electrode 41a exposed to the first measurement gas sub-chamber 11a, and a common electrode 53 which is exposed to a reference gas chamber 12 and is shared with the sensor cell 2.

The electromotive force is creased between the monitor cell electrode 41a and the common electrode 53 as a function of a difference in concentration of oxygen between the measurement gas chamber 11 and the reference gas chamber 12 exposed to the atmospheric air.

The reference gas chamber 12 is kept constant in concentration of oxygen, so that the monitor cell electrode 41a and the common electrode 53 produce the electromotive force as a function of concentration of oxygen within the first measurement gas sub-chamber 11a. Keeping the concentration of oxygen in the measurement gas chamber flowing into the second measurement gas sub-chamber 11b at a constant level is, therefore, achieved by controlling the voltage applied to the pump cell 3 so as to kept the electromotive force at a constant level of, for example, 0.2 V.

The pump cell 3 is, as can be seen from FIG. 8, made by a combination of a first pump cell 3a and a second pump cell 3b. The second pump cell 3b works to pump oxygen, which has flowed into the second measurement gas chamber 11b without being discharged by the first pup cell 3a, outside the gas sensor element 1, so that the concentration of oxygen within the second measurement gas sub-chamber 11b is decreased to approximately zero (0). This enables the sensor cell 2 to measure the concentration of NOx within the second measurement gas sub-chamber 11a with high accuracy.

The first pump cell 3a, as illustrated in FIG. 8, has a pump cell electrode 31a covered with the porous diffusion resistance layer 17 and a pump cell electrode 31b facing the first measurement gas sub-chamber 11a which are connected to the pump circuit 730. The second pump cell 3b has the pump cell electrode 31a shared with the first pump cell 3a and a pump cell electrode 31c facing the second measurement gas sub-chamber 11b which are connected to a second pump circuit 731.

The sensor cell 2 and the monitor cell 4 extend in alignment with each other in a lengthwise direction of the gas sensor element 1. The sensor cell 2 consists of the solid electrolyte plate 20, the sensor cell electrode 21a facing the measurement gas chamber 11, and the common electrode 53 shared with the monitor cell 4 within the reference gas chamber 12. The sensor cell electrode 21a and the common electrode 53 are connected to the sensor circuit 720. Other arrangements and operations are identical with those in the first embodiment, and explanation thereof in detail will be omitted here.

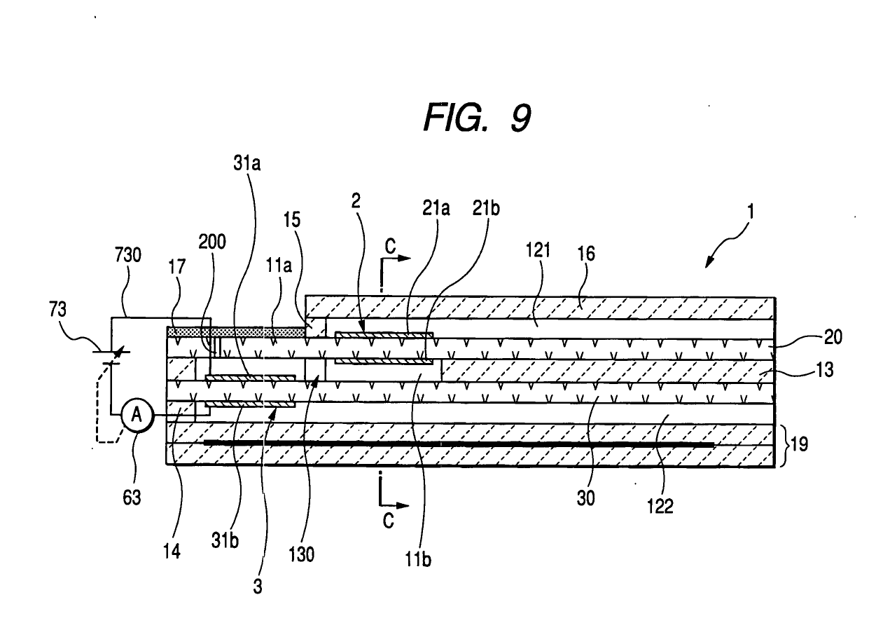

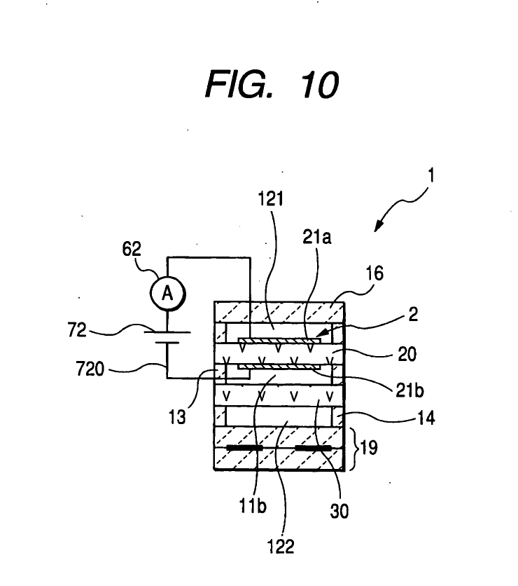

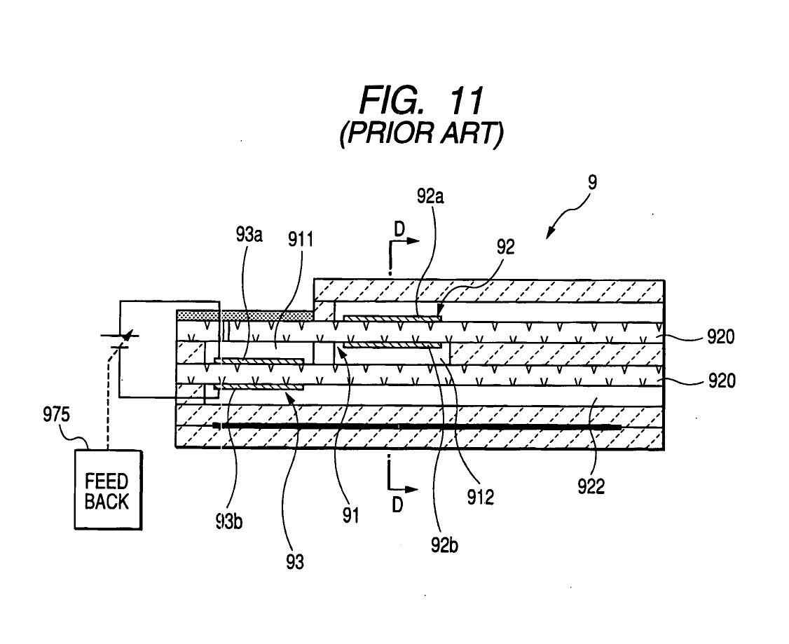

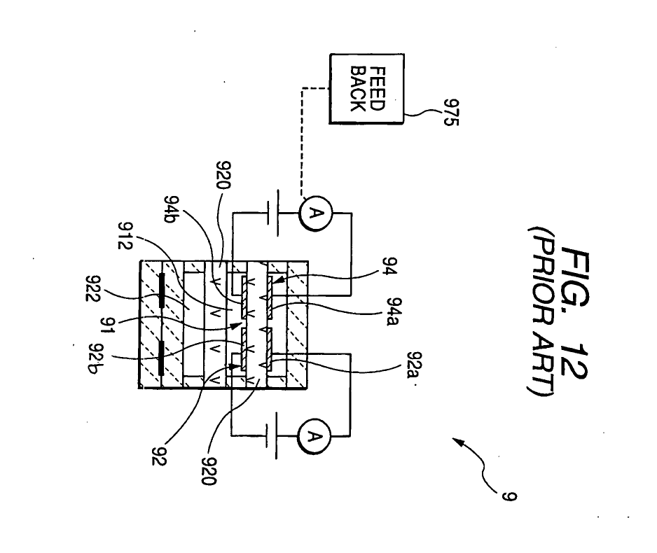

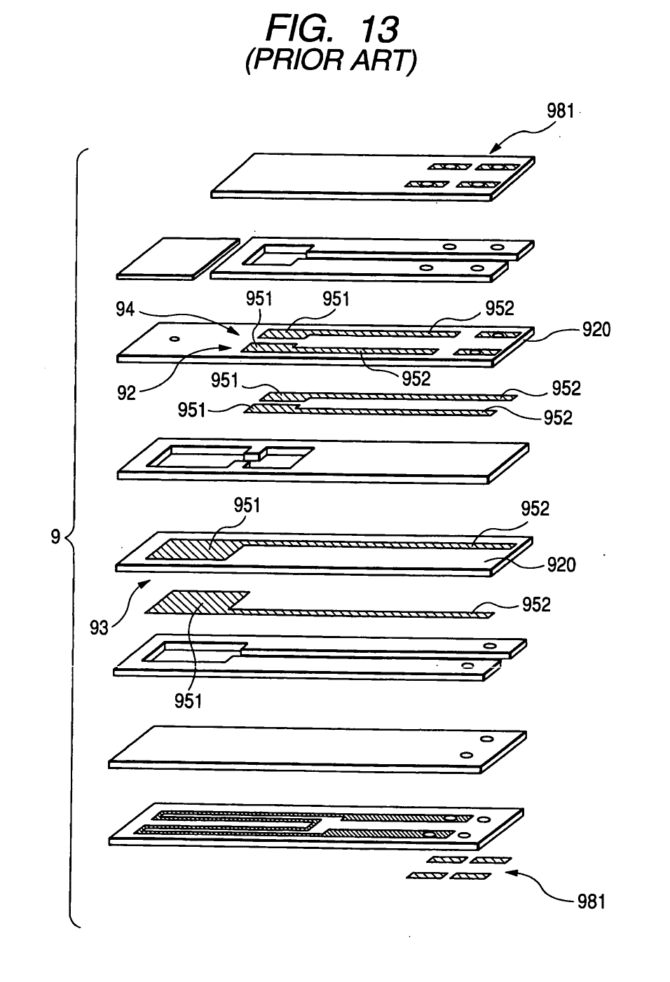

FIGS. 9 and 10 show the gas sensor element 1 of the fifth embodiment of the invention which does not include the monitor cell 4 and is employed in a limiting current control system in which the pump circuit 730 works to look up a map table stored therein which lists relations between voltages to be applied to the pump cell 3 and resultant currents flowing through the pump cell 3 to determine a target voltage to be applied to the pump cell 3 as a function the concentration of oxygen in the first measurement gas sub-chamber 11a, which results in production of a limiting current between the pump cell electrodes 31a and 31b, thereby keeping the concentration of oxygen in the second measurement gas sub-chamber 11b at a given lower level.

The absence of the monitor cell 4 working to monitor the concentration of oxygen in the second measurement gas sub-chamber 11b requires the pump cell 3 to discharge the oxygen out of the measurement gas chamber 11 and minimization of entrance of oxygen gas from portions of the gas sensor element 1, such as the leads 22b, 32a, etc., other than the pinhole 200 in order to secure the high accuracy in determining the concentration of NOx. Other arrangements and operations are identical with those in the first embodiment, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor element comprising:
a measurement gas chamber into which a measurement gas enter;
a sensor cell working to produce a signal as a function of a concentration of a given gas component contained in the measurement gas within said measurement gas chamber, said sensor cell including an oxygen ion-conductive solid electrolyte body and a first and a second sensor cell electrode affixed to surfaces of the solid electrolyte body, the second sensor cell electrode being exposed to said measurement gas chamber,
a first and a second sensor cell terminal disposed on surfaces of the gas sensor element;
a first sensor cell lead connecting between the first sensor cell electrode and said first sensor cell terminal; and
a second sensor cell lead connecting between the second sensor cell electrode and said second sensor cell terminal, at least a portion of said second sensor cell lead being made of material which includes a mixture of a metallic composition and a ceramic composition and contains 7% or less by weight of the ceramic composition based on a total weight of the mixture.

2. A gas sensor element as set forth in claim 1, wherein the at least the portion of said second sensor cell lead contains 1% or more by weight of the ceramic composition based on the total weight of the mixture.

3. A gas sensor element as set forth in claim 1, further comprising a pump cell, a first and a second pump cell terminal, and a first and a second pump cell lead, the pump cell working to regulate a concentration of oxygen within said measurement gas chamber to a given level and including an oxygen ion-conductive solid electrolyte body and a first and a second pump cell electrode affixed to surfaces of the solid electrolyte body, the second pump cell electrode being exposed to said measurement gas chamber, said first and second pump cell terminals being disposed on surfaces of the gas sensor element, said first pump cell lead connecting between the first pump cell electrode and said first pump cell terminal electrically, said second pump cell lead connecting between the second pump cell electrode and said second pump cell terminal, at least a portion of said second pump cell lead being made of material which includes a mixture of a metallic composition and a ceramic composition and contains 7% or less by weight of the ceramic composition based on a total weight of the mixture.

4. A gas sensor element as set forth in claim 3, wherein the at least the portion of said second pump cell lead contains 1% or more by weight of the ceramic composition based on the total weight of the mixture.

5. A gas sensor element as set forth in claim 1, further comprising a monitor cell, a first and a second monitor cell terminal, and a first and a second monitor cell lead, the monitor cell working to monitor a concentration of oxygen within said measurement gas chamber and including an oxygen ion-conductive solid electrolyte body and a first and a second monitor cell electrode affixed to surfaces of the solid electrolyte body, the second monitor cell electrode being exposed to said measurement gas chamber, said first and second monitor cell terminals being disposed on surfaces of the gas sensor element, said first monitor cell lead connecting between the first monitor cell electrode and said first monitor cell terminal electrically, said second monitor cell lead connecting between the second monitor cell electrode and said second monitor cell terminal, at least a portion of said second monitor cell lead being made of material which includes a mixture of a metallic composition and a ceramic composition and contains 1% to 7% by weight of the ceramic composition based on a total weight of the mixture.

6. A gas sensor element as set forth in claim 1, wherein each of the first and second sensor cell leads contains a metallic composition of Rh.

7. A gas sensor element as set forth in claim 3, wherein each of the first and second pump cell leads contains a metallic composition of Rh.

8. A gas sensor element as set forth in claim 5, wherein each of the first and second monitor cell leads contains a metallic composition of Rh.

9. A gas sensor element as set forth in claim 1, wherein each of the first and second sensor cell leads has a thickness of 5 μm or less.

10. A gas sensor element as set forth in claim 3, wherein each of the first and second pump cell leads has a thickness of 5% m or less.

11. A gas sensor element as set forth in claim 5, wherein each of the first and second monitor cell leads has a thickness of 5 μm or less.

12. A gas sensor element as set forth in claim 5, further comprising a pump cell which is responsive to application of voltage thereto to regulate the concentration of oxygen within said measurement gas chamber to a given level, and wherein said monitor cell produces a signal indicative of the concentration of oxygen within said measurement gas chamber for use in controlling the voltage applied to said pump cell.

13. A gas sensor element as set forth in claim 1, wherein said sensor cell works to produce an electric current as a function of the concentration of the given gas component contained in the measurement gas within said measurement gas chamber.

14. A gas sensor element as set forth in claim 1, wherein the given gas component is a nitrogen oxide.

15. A gas sensor element comprising:
a measurement gas chamber into which a measurement gas enter;
a sensor cell working to produce a signal as a function of a concentration of a given gas component contained in the measurement gas within said measurement gas chamber, said sensor cell including an oxygen ion-conductive solid electrolyte body and a first and a second sensor cell electrode affixed to surfaces of the solid electrolyte body, the second sensor cell electrode being exposed to said measurement gas chamber;
a first and a second sensor cell terminal disposed on surfaces of the gas sensor element;
a first sensor cell lead connecting between the first sensor cell electrode and said first sensor cell terminal; and
a second sensor cell lead connecting between the second sensor cell electrode and said second sensor cell terminal, at least a portion of said second sensor cell lead contains a glass composition.

16. A gas sensor element as set forth in claim 15, further comprising a pump cell, a first and a second pump cell terminal, and a first and a second pump cell lead, the pump cell working to regulate a concentration of oxygen within said measurement gas chamber to a given level and including an oxygen ion-conductive solid electrolyte body and a first and a second pump cell electrode affixed to surfaces of the solid electrolyte body, the second pump cell electrode being exposed to said measurement gas chamber, said first and second pump cell terminals being disposed on surfaces of the gas sensor element, said first pump cell lead connecting between the first pump cell electrode and said first pump cell terminal electrically, said second pump cell lead connecting between the second pump cell electrode and said second pump cell terminal, at least a portion of said second pump cell lead containing a glass composition.

17. A gas sensor element as set forth in claim 15, further comprising a monitor cell, a first and a second monitor cell terminal, and a first and a second monitor cell lead, the monitor cell working to monitor a concentration of oxygen within said measurement gas chamber and including an oxygen ion-conductive solid electrolyte body and a first and a second monitor cell electrode affixed to surfaces of the solid electrolyte body, the second monitor cell electrode being exposed to said measurement gas chamber, said first and second monitor cell terminals being disposed on surfaces of the gas sensor element, said first monitor cell lead connecting between the first monitor cell electrode and said first monitor cell terminal electrically, said second monitor cell lead connecting between the second monitor cell electrode and said second monitor cell terminal, at least a portion of said second monitor cell lead containing a glass composition.

18. A gas sensor element as set forth in claim 15, wherein each of the first and second sensor cell leads contains a metallic composition of Rh.

19. A gas sensor element as set forth in claim 15, wherein each of the first and second sensor cell leads has a thickness of 5 μm or less.

20. A gas sensor element as set forth in claim 16, wherein each of the first and second pump cell leads has a thickness of 5 μm or less.

21. A gas sensor element as set forth in claim 17, wherein each of the first and second monitor cell leads has a thickness of 5 μm or less.

22. A gas sensor element as set forth in claim 17, further comprising a pump cell which is responsive to application of voltage thereto to regulate the concentration of oxygen within said measurement gas chamber to a given level, and wherein said monitor cell produces a signal indicative of the concentration of oxygen within said measurement gas chamber for use in controlling the voltage applied to said pump cell.

23. A gas sensor element as set forth in claim 15, wherein said sensor cell works to produce an electric current as a function of the concentration of the given gas component contained in the measurement gas within said measurement gas chamber.

24. A gas sensor element as set forth in claim 15, wherein the given gas component is a nitrogen oxide.
